(19) United States
(12) Patent Application Publication
(10) Pub. No.: US 2014/0049359 A1
(43) Pub. Date: Feb. 20, 2014

(54) SECURITY DEVICE AND INTEGRATED CIRCUIT INCLUDING THE SAME

(71) Applicant: SAMSUNG ELECTRONICS CO., LTD., Suwon-si (KR)

(72) Inventor: Sebastien RIOU, Seongnam-si (KR)

(73) Assignee: SAMSUNG ELECTRONICS CO., LTD., Suwon-si (KR)

(21) Appl. No.: 13/964,325

(22) Filed: Aug. 12, 2013

(30) Foreign Application Priority Data
Aug. 14, 2012 (KR) 10-2012-0088957

(51) Int. Cl. G06F 21/70

(52) U.S. Cl. CPC G06F 21/70
USPC 340/5.2

(57) ABSTRACT

A security device includes a shield having at least one first and second conductive wire, first and second logic units, and a detecting unit. The first logic unit is configured to receive a first pattern signal, transmit data based on the first pattern signal through the at least one first conducting wire, and output a detection pattern signal based on data received through the at least one second conducting wire. The second logic unit is configured to perform a logical operation on the data received through the at least one first conducting wire, and transmit a result of the logical operation through the at least one second conducting wire. The detecting unit is configured to provide the first pattern signal to the first logic unit, receive the detection pattern signal from the first logic unit, and detect an unauthorized access attempt.

### CROSS-REFERENCE TO RELATED APPLICATIONS

This application claims priority under 35 U.S.C. §119 to Korean Patent Application No. 10-2012-0088957, filed on Aug. 14, 2012, the disclosure of which is incorporated by reference herein in its entirety.

### TECHNICAL FIELD

Exemplary embodiments of the inventive concept relate to a security device and an integrated circuit including the same, and more particularly, to a security device capable of preventing unauthorized access to an integrated circuit, and an integrated circuit including the security device.

### DISCUSSION OF THE RELATED ART

Integrated circuits including a secure circuit (e.g., a circuit for which a high level of security may be required) such as, for example, a smart card, may be used to store sensitive information such as a digital signature, an encryption code, etc. As a result, such integrated circuits may be targeted by unauthorized users (e.g., hackers) in an effort to obtain the sensitive information stored therein, or to change an operation of the integrated circuit. Various methods, including probing, may be utilized by unauthorized users for these purposes.

For example, unauthorized users may probe internal signals of an integrated circuit while the integrated circuit performs important operations such as, for example, encryption or code loading. The probing may allow unauthorized users to effectively obtain the sensitive information stored in the integrated circuit without additional processing of extracted data within a relatively short time.

### SUMMARY

Exemplary embodiments of the inventive concept provide a security device for preventing unauthorized access to an integrated circuit, and more particularly, a security device for controlling and monitoring data transmitted through a plurality of conducting wires, and an integrated circuit including the security device.

According to an exemplary embodiment of the inventive concept, a security device includes a shield including at least one first and second conducting wire, a first logic unit configured to receive a first pattern signal, transmit data based on the first pattern signal through the at least one first conducting wire, and output a detection pattern signal based on data received through the at least one second conducting wire, a second logic unit configured to perform a logical operation on the data received through the at least one first conducting wire and transmit a result of the logical operation through the at least one second conducting wire, and a detecting unit configured to provide the first pattern signal to the first logic unit, receive the detection pattern signal from the first logic unit, and detect an unauthorized access attempt.

According to an exemplary embodiment of the inventive concept, an integrated circuit including a plurality of layers includes a shield disposed on a first layer from among the plurality of layers and including at least one first and second conducting wire, a first logic unit disposed on the first layer and configured to receive a first pattern signal, transmit data based on the first pattern signal through the at least one first conducting wire, and output a detection pattern signal based on data received through the at least one second conducting wire, a second logic unit disposed on the first layer and configured to perform a logical operation on the data received through the at least one first conducting wire, and transmit a result of the logical operation through the at least one second conducting wire, a secure circuit unit disposed on a second layer disposed below the first layer, and a detecting unit disposed on the second layer and configured to provide the first pattern signal to the first logic unit, receive the detection pattern signal from the first logic unit, and detect an unauthorized access attempt.

According to an exemplary embodiment of the inventive concept, a security device includes a logic circuit disposed on a top layer of an integrated circuit, and configured to output a detection pattern signal, a secure circuit disposed on a lower layer of the integrated circuit, and a detecting unit disposed on the lower layer, and configured to receive the detection pattern signal from the logic circuit, provide a pattern signal and a control signal to the logic circuit, and provide an error signal to the secure circuit indicating an unauthorized access attempt based on a comparison of the detection pattern signal and an expectation pattern signal.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram of a security device and an integrated circuit including the security device, according to an exemplary embodiment of the inventive concept.

FIG. 2 is a block diagram of a detecting unit shown in FIG. 1, according to an exemplary embodiment of the inventive concept.

FIG. 3 is a block diagram of a pattern generating unit shown in FIG. 2, according to an exemplary embodiment of the inventive concept.

FIG. 4 illustrates an operation of a random number generator shown in FIG. 3, according to an exemplary embodiment of the inventive concept.

FIG. 5 illustrates a structure of a top layer of an integrated circuit, according to an exemplary embodiment of the inventive concept.

FIG. 6 illustrates first and second logic units disposed in a top layer of an integrated circuit, according to an exemplary embodiment of the inventive concept.

FIGS. 7A through 7D illustrate first logic units disposed in a top layer of an integrated circuit, according to exemplary embodiments of the inventive concept.

FIG. 8 illustrates a second logic disposed in a top layer of an integrated circuit, according to an exemplary embodiment of the inventive concept.

FIG. 9 is a flowchart showing a method of an operation of a security device, according to an exemplary embodiment of the inventive concept.

FIGS. 10A and 10B respectively show a plan view and a cross-sectional view of a smart card including a security device, according to an exemplary embodiment of the inventive concept.

FIG. 11 is a block diagram of an integrated circuit including a security device, according to an exemplary embodiment of the inventive concept.

### DETAILED DESCRIPTION OF THE EXEMPLARY EMBODIMENTS

Exemplary embodiments of the inventive concept will be described more fully hereinafter with reference to the accompanying drawings. Like reference numerals may refer to like elements throughout the accompanying drawings.

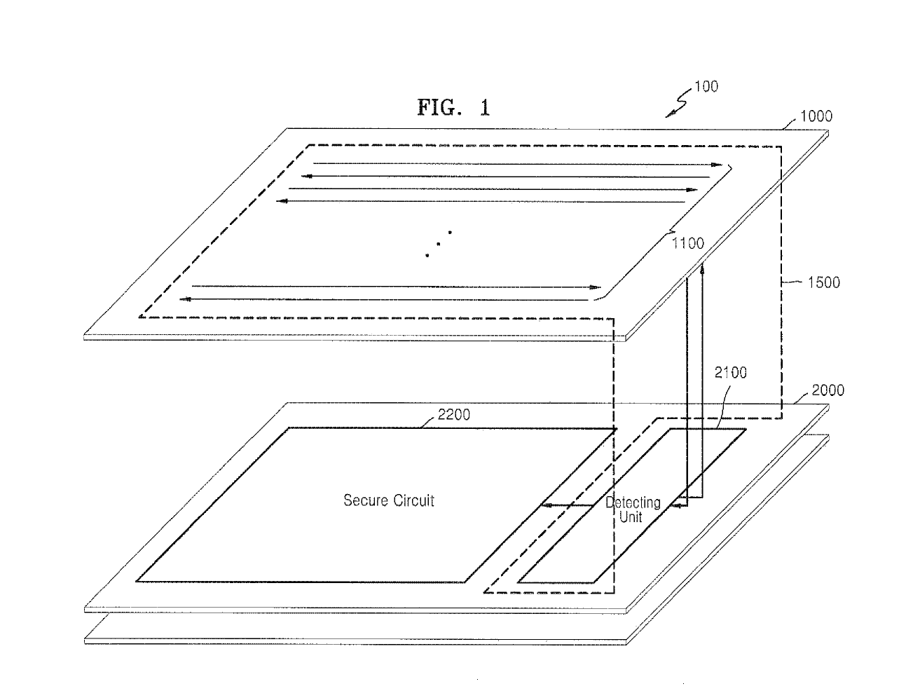

FIG. 1 is a block diagram of a security device 1500 and an integrated circuit 100 including the security device 1500, according to an exemplary embodiment of the inventive concept. The integrated circuit 100 shown in FIG. 1 includes a plurality of layers, each of which includes various types of circuits such as, for example, a processor, a memory, etc. For example, as shown in FIG. 1, the integrated circuit 100 includes a first layer including a plurality of conducting wires 1100, and a second layer including a detecting unit 2100. The detecting unit 2100 may control data transmission through the conducting wires 1100. The first layer including the conducting wires 1100 may be a top layer from among a plurality of layers, and the second layer including the detecting unit 2100 may be any one of a plurality of lower layers disposed below the first layer. Herein, the first layer including the conducting wires 1100 is referred to as a top layer 1000, and the second layer including the detecting unit 2100 is referred to as a lower layer 2000.

The top layer 1000 includes the conducting wires 1100, through which digital data is transmitted. Herein, a region occupied by the conducting wires 1100 may be referred to as a shield. The lower layer 2000 may be disposed below the top layer 1000 and may include the detecting unit 2100, which may detect a disconnection or short circuit of the conducting wires 1100 and a secure circuit 2200. The secure circuit 2200 is a circuit for which a high level of security (e.g., protection against unauthorized access) may be required. The security device 1500 protects the secure circuit 2200 from unauthorized access attempts, and may include the conducting wires 1100 and the detecting unit 2100.

The detecting unit 2100 controls and monitors data that is transmitted through the conducting wires 1100 disposed on the top layer 1000. When an unauthorized access attempt occurs, a data value of data being transmitted through the conducting wires 1100 may be changed. Thus, monitoring the data value allows for the detection of an unauthorized access attempt. When the data value is changed, the detecting unit 2100 may output an error signal indicating that an unauthorized access attempt has been made. The secure circuit 2200 may include a circuit that stores data that is to be protected from unauthorized access attempts, and/or a circuit that performs secure operations. The circuit that stores protected data and the circuit that performs secure operations may be different circuits or the same circuit. The secure circuit 2200 may receive the error signal from the detecting unit 2100 and may perform a required operation in response to receiving the error signal. For example, the secure circuit 2200 may change data or may process the data in such a way that the secure circuit 2200 may not perform a normal operation, in response to the data received from the detecting unit 2100. That is, to prevent the likelihood of unauthorized users being able to obtain sensitive information stored in the secure circuit 2200, a normal operation of the secure circuit 2200 may be modified.

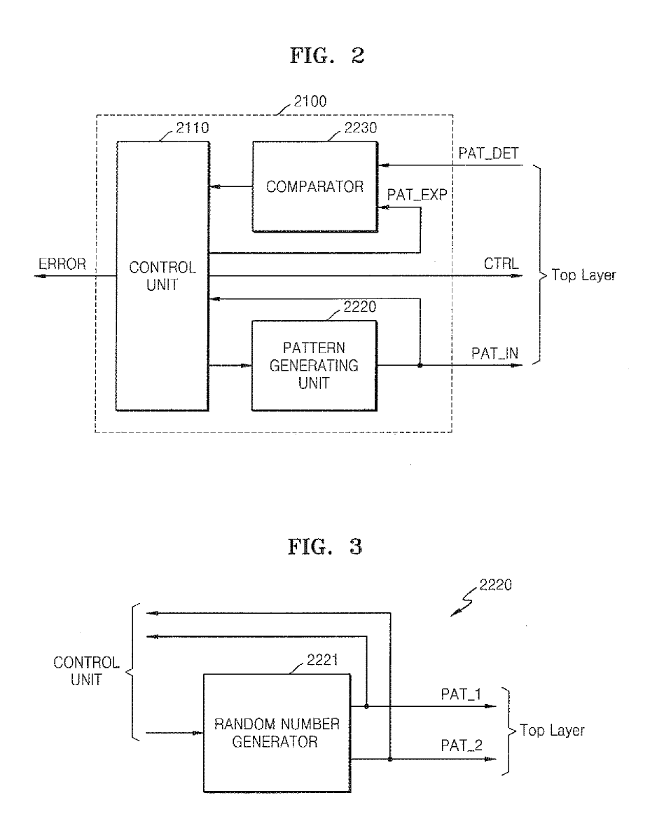

FIG. 2 is a block diagram of the detecting unit 2100 shown in FIG. 1, according to an exemplary embodiment of the inventive concept. Referring to FIGS. 1 and 2, the detecting unit 2100 communicates with the top layer 1000 and controls data transmitted through the conducting wires 1100 of the top layer 1000. The detecting unit 2100 further detects unauthorized access attempts. For example, as shown in FIG. 2, the detecting unit 2100 may transmit a pattern signal PAT_IN to the top layer 1000 and may output a control signal CTRL that controls the data transmitted through the conducting wires 1100 of the top layer 1000. The control signal CTRL may include, for example, a shift signal, a selection signal, an output enable signal, etc. In addition, the detecting unit 2100 may receive a detection pattern signal PAT_DET from the top layer 1000. Utilization of the pattern signal PAT_IN and the detection pattern signal PAT_DET are described in further detail below. When an unauthorized access attempt is made, the detecting unit 2100 may provide an error signal ERROR to the secure circuit 2200.

According to an exemplary embodiment of the inventive concept, the detecting unit 2100 includes a control unit 2110, a pattern generating unit 2220, and a comparator 2230. The control unit 2110 may control the pattern generating unit 2220, may receive the pattern signal PAT_IN generated by the pattern generating unit 2220, and may output an expectation pattern signal PAT_EXP. The control unit 2110 may include a state machine and may output the error signal ERROR externally from the detecting unit 2100 in response to a comparison result output from the comparator 2230 to the control unit 2110. The pattern generating unit 2220 generates at least one pattern signal PAT_IN, and may output the pattern signal PAT_IN externally from the detecting unit 2100. The comparator 2230 receives the detection pattern signal PAT_DET from the top layer 1000, receives the expectation pattern signal PAT_EXP from the control unit 2110, and compares the detection pattern signal PAT_DET and the expectation pattern signal PAT_EXP with each other. The comparator 2230 outputs a signal(s) to the control unit 2110 indicating whether the detection pattern signal PAT_DET matches the expectation pattern signal PAT_EXP.

FIG. 3 is a block diagram of the pattern generating unit 2220 shown in FIG. 2, according to an exemplary embodiment of the inventive concept. Referring to FIGS. 2 and 3, the pattern generating unit 2220 includes a random number generator 2221 that generates a random number. The random number generator 2221 may generate at least one irregular number. For example, as shown in FIG. 3, the random number generator 2221 may be controlled by the control unit 2110, and may generate a first pattern signal PAT_1 of the pattern signal PAT_IN and a second pattern signal PAT_2 of the pattern signal PAT_IN. The first pattern signal PAT_1 and the second pattern signal PAT_2 may be externally transmitted to the top layer 1000, may be internally transmitted within the detecting unit 2100 from the pattern generating unit 2220 to the control unit 2110, and may be used to generate the expectation pattern signal PAT_EXP.

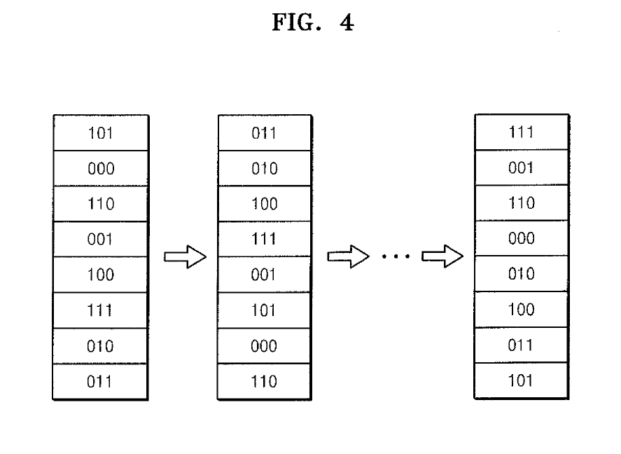

FIG. 4 illustrates an operation of the random number generator 2221 shown in FIG. 3, according to an exemplary embodiment of the inventive concept. The random number generator 2221 shown in FIG. 3 may include a pseudo random number generator that generates each of all possibly generable numbers at least once during a single period. For example, as shown in FIG. 4, when the pseudo random number generator generates a random number of 3 bits, every possible combination may be generated at least one time during a single period (e.g., all possible 8 pseudo random numbers from 000 through 111 may be generated). Alternatively, an order of numbers generated during a single period may be irregularly changed for each respective period.

The pseudo random number generator may include a counter and a true random number generator. The counter may sequentially generate all numbers during a single period. The pseudo random number generator may rearrange an order of the numbers that are generated by the counter during a single period, and may output the numbers externally, in response to a random number generated by the true random number generator. Using the pseudo random number generator, the detecting unit 2100 may detect that an unauthorized access attempt has been made within a predetermined period of time. That is, the detecting unit 2100 may detect a disconnection or short circuit of first or second conducting wirings 1110 and 1120 within the single period.

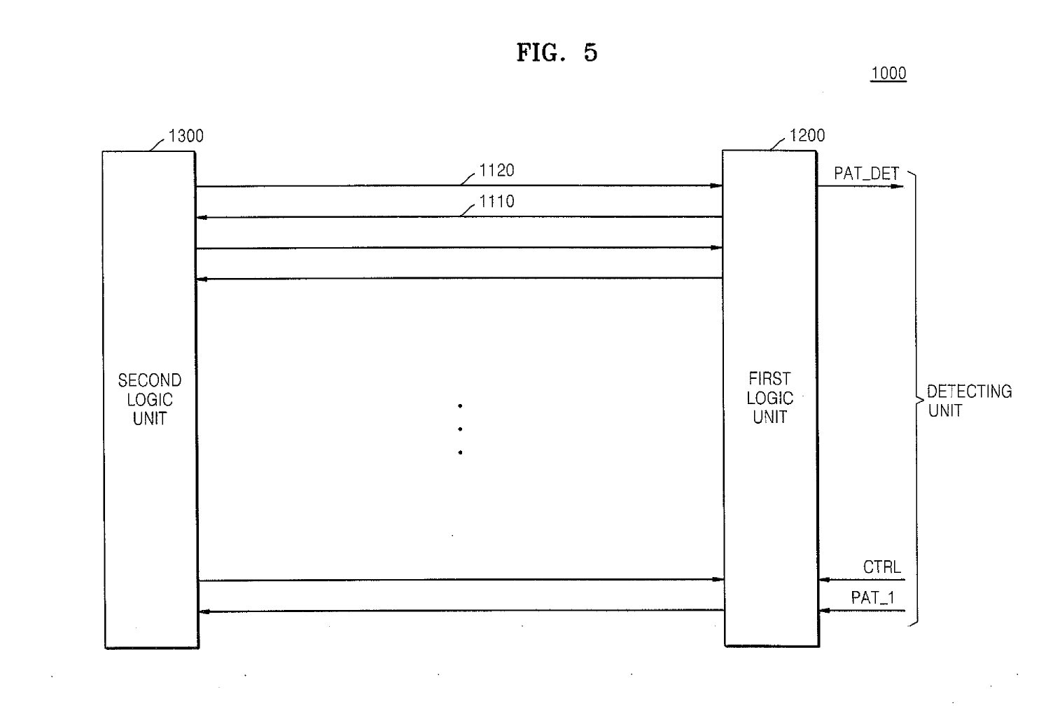

FIG. 5 illustrates a structure of a top layer 1000 of an integrated circuit 100, according to an exemplary embodiment of the inventive concept. When a shield is disposed on the top layer 1000 of the integrated circuit 100, it may be possible for an unauthorized user (e.g., a hacker) to disable or circumvent the shield to gain access to the secure circuit 2200. To prevent or reduce the likelihood of this occurring, the shield in exemplary embodiments of the inventive concept may include a plurality of conducting wires, and may detect an unauthorized access attempt by transmitting and receiving data through the conducting wirings and monitoring the data.

As shown in FIG. 5, the top layer 1000 according to an exemplary embodiment of the inventive concept includes a plurality of first conducting wires 1110 and a plurality of second conducting wires 1120, which transmit data, and a first logic unit 1200 and a second logic unit 1300, which transmit and receive data through the first conducting wires 1110 and the second conducting wires 1120. The first logic unit 1200 transmits data to the second logic unit 1300 through the first conducting wires 1110, and receives data from the second logic unit 1300 through the second conducting wires 1120. The second logic unit 1300 transmits data to the first logic unit 1200 through the second conducting wires 1120, and receives data from the first logic unit 1200 through the first conducting wires 1110.

The first logic unit 1200 communicates with the detecting unit 2100 shown in FIG. 1 and controls data transmitted through the first conducting wires 1110. For example, as shown in FIG. 5, the first logic unit 1200 may receive the first pattern signal PAT_1 from the detecting unit 2100 and may transmit the first pattern signal PAT_1 to the second logic unit 1300 through at least one of the first conducting wires 1110. In addition, the detecting unit 2100 may transmit the control signal CTRL to the first logic unit 1200 such that the first logic unit 1200 may adjust a point of time for transmitting data through the first conducting wires 1110. The control signal CTRL may include, for example, a shift signal, a selection signal, an output enable signal, etc. The first logic unit 1200 may transmit the detection pattern signal PAT_DET to the detecting unit 2100 based on data received through the second conducting wires 1120.

The second logic unit 1300 may include a combinational logic circuit, may perform a logical operation on data that is received from the first logic unit 1200 through the first conducting wires 1110, and may transmit the resulting data to the first logic unit 1200 through the second conducting wires 1120. The second logic unit 1300 is described in further detail below.

The first conducting wires 1110 and the second conducting wires 1120 shown in FIG. 5 are arranged parallel to each other, and each have a straight line shape. Alternatively, the first conducting wires 1110 and the second conducting wires 1120 may be bent, as long as the first conducting wires 1110 and the second conducting wires 1120 do not become connected to each other as a result of their bent shape. Although conducting wires included in the first conducting wires 1110 and the second conducting wires 1120 shown in FIG. 5 are alternately arranged, the arrangement of the conducting wires is not limited thereto. For example, a plurality of conducting wires included in each of the first conducting wires 1110 and the second conducting wires 1120 may be collectively arranged in a variety of configurations.

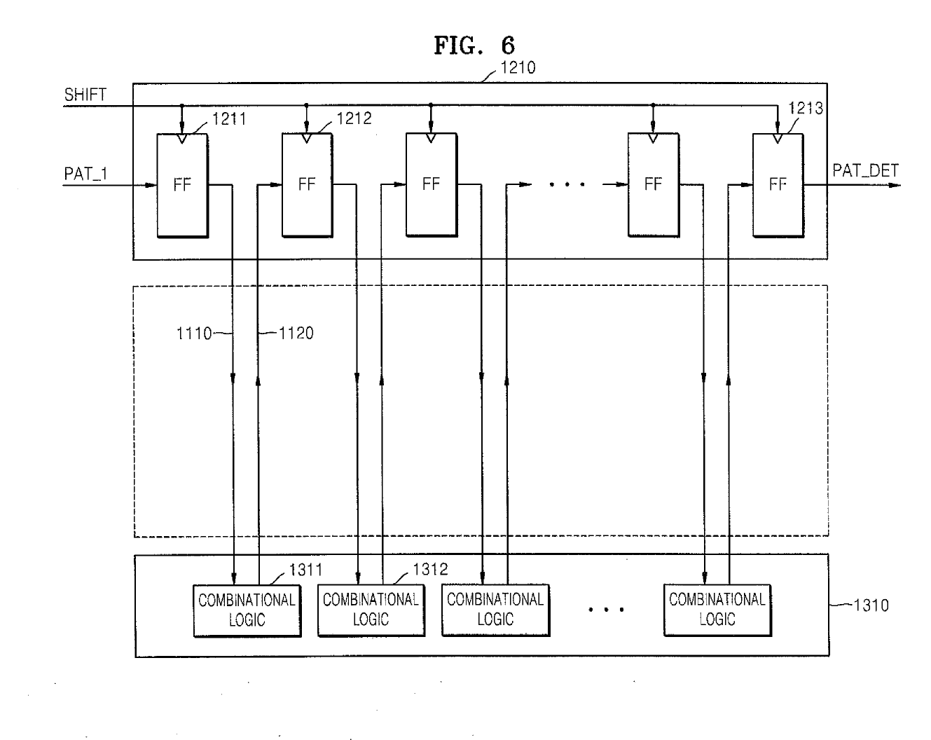

FIG. 6 illustrates first and second logic units 1210 and 1310, which are modified versions of the first and second logic units 1200 and 1300 of FIG. 5, according to an exemplary embodiment of the inventive concept. As shown in FIG. 6, the first logic unit 1210 according to an exemplary embodiment includes a plurality of flip-flops FF. A shift signal SHIFT received from the detecting unit 2100 may be input into a clock terminal of each flip-flop, and the detection pattern signal PAT_DET transmitted to the detecting unit 2100 may be output from an output terminal of each flip-flop. The first pattern signal PAT_1 that is received by the first logic unit 1210 from the detecting unit 2100 may be input into an input terminal of an input flip-flop 1211, and the detection pattern signal PAT_DET transmitted to the detecting unit 2100 may be output from an output terminal of an output flip-flop 1213. Input terminals of one or more transmission flip-flops 1212 may be connected to the second conducting wires 1120, and output terminals of the one or more transmission flip-flops 1212 may be connected to the first conducting wires 1110.

The second logic unit 1310 may include a plurality of combinational logic circuits. An input terminal of each combinational logic circuit may be connected to the first conducting wires 1110, and an output terminal of each combinational logic circuit may be connected to the second conducting wires 1120. The combinational logic circuits may be designed to perform different logical operations. For example, referring to FIG. 6, a first combinational logic circuit 1311 and a second combinational logic circuit 1312 may output different pieces of data in response to the same input data.

According to exemplary embodiments of the inventive concept, to prevent unauthorized users from being able to predict signals transmitted through the first conducting wires 1110 and the second conducting wires 1120, the detecting unit 2100 may stop transmitting the shift signal SHIFT to the first logic unit 1200 or 1210. For example, the detecting unit 2100 may stop transmitting the shift signal SHIFT, and as a result, data that is transmitted and received through the first conducting wires 1110 and the second conducting wires 1120 may be retained. In addition, the detecting unit may 2100 may irregularly transmit the shift signal SHIFT to prevent unauthorized users from being able to predict data that is transmitted through the first conducting wires 1110 and the second conducting wires 1120, thereby preventing or reducing the likelihood of the hacking of a security device. Irregularly transmitting the shift signal SHIFT may refer to adjusting the time at which the SHIFT signal is transmitted.

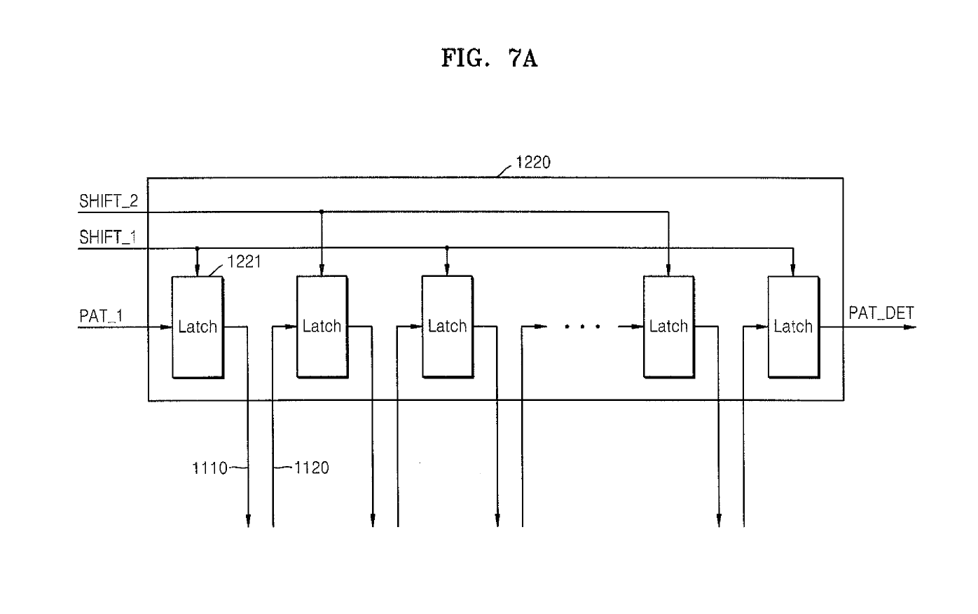

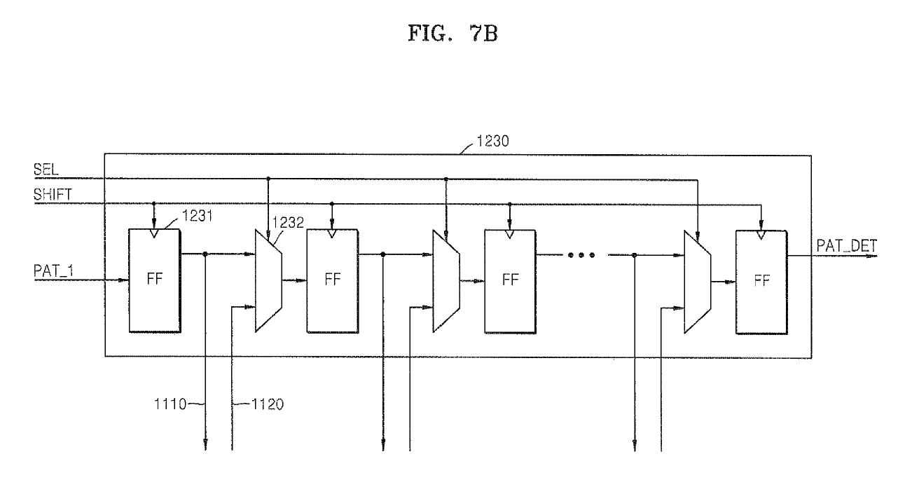

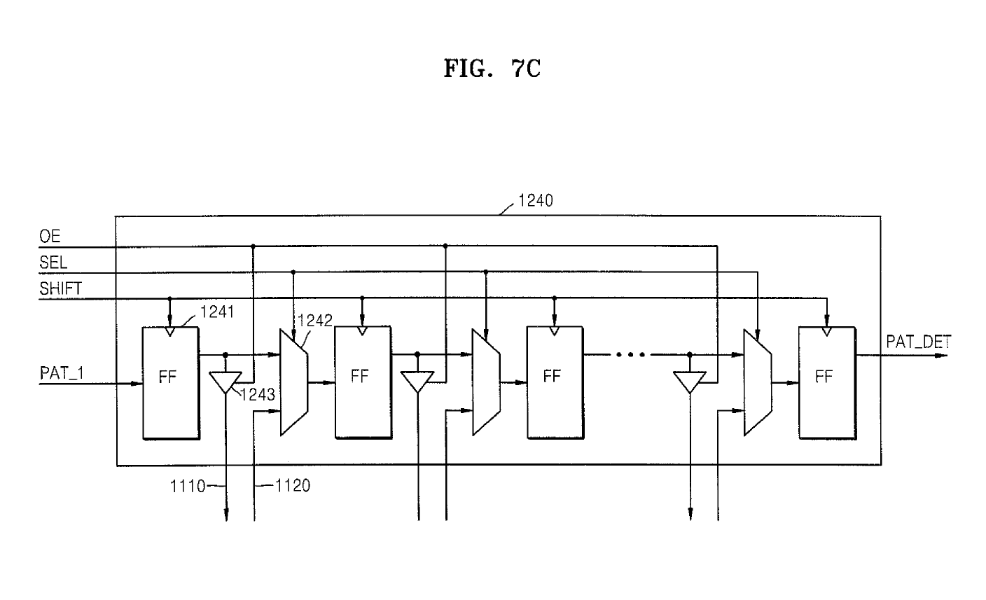

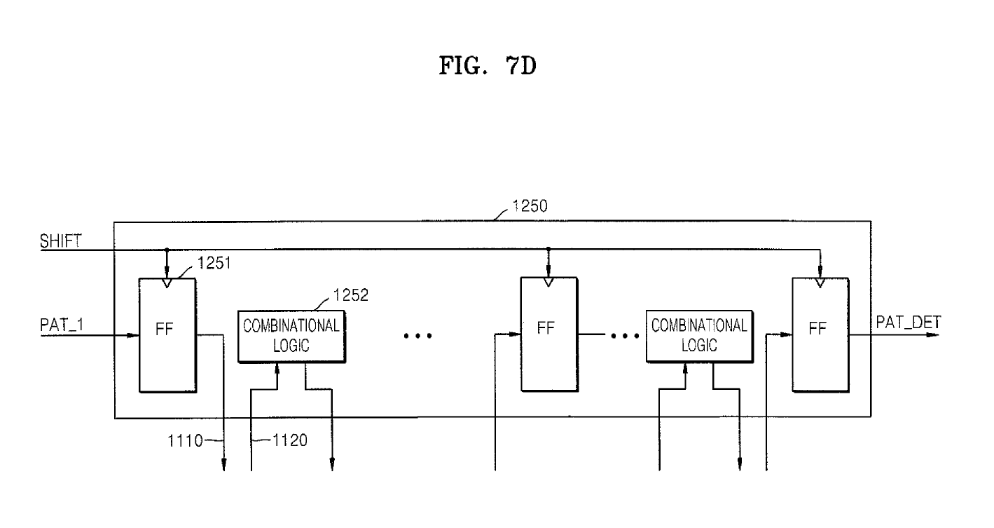

FIGS. 7A through 7D illustrate first logic units 1220, 1230, 1240, and 1250, which are modified versions of the first logic unit 1200 of FIG. 5, according to exemplary embodiments of the inventive concept. The first logic units 1220, 1230, 1240, and 1250 may include various logic circuits, may receive a control signal from the detecting unit 2100, and may transmit and receive data to and from a second logic unit 1300 through the first and second conducting wires 1110 and 1120. Herein, when reference is made to the first logic unit 1200, it is to be understood that the referenced first logic unit 1200 may be replaced with any of the first logic units 1220, 1230, 1240, and 1250.

FIG. 7A illustrates a first logic unit 1220, according to an exemplary embodiment of the inventive concept. A flip-flop may output input data in response to a rising edge or a falling edge of a clock signal. In FIG. 7A, a latch 1221 may output input data when a signal received as an enable input is enabled. The latch 1221 may be embodied using a small number of transistors. As a result, the space occupied by the first logic unit 1220 in the integrated circuit 100 may be reduced. Rather than utilizing a single shift signal SHIFT in a manner similar to a flip-flop, adjacent latches 1221 may receive a first shift signal SHIFT_1 and a second shift signal SHIFT_2, and the detecting unit 2100 may enable the first shift signal SHIFT_1 and the second shift signal SHIFT_2 that are transmitted to the first logic unit 1220 at different points of time.

FIG. 7B illustrates a first logic unit 1230, according to an exemplary embodiment of the inventive concept. Input terminals of a multiplexer 1232 may be connected to an output terminal of an adjacent flip-flop 1231 and at least one of the second conductive wires 1120. In this case, the output terminal of the adjacent flip-flop 1231 may be connected to any one of the input terminals of the multiplexer 1232 in response to a selection signal SEL. An output terminal of the multiplexer 1232 may be connected to an input terminal of another adjacent flip-flop. In an initial operation of the security device 1500, the detecting unit 2100 may control the selection signal SEL such that the output terminal of the multiplexer 1232 may be connected to the output terminal of the adjacent flip-flop. In addition, until the first logic unit 1230 outputs a plurality of first pattern signals PAT_1 through the first conducting wires 1110, the detecting unit 2100 may generate an edge of the shift signal SHIFT, and may simultaneously transmit a series of the first pattern signals PAT_1 to the first logic unit 1230. Then, the detecting unit 2100 may control the selection signal SEL such that the multiplexer 1232 may output data received through the second conducting wires 1120. The detecting unit 2100 may generate an edge of the shift signal SHIFT and may receive the detection pattern signal PAT_DET to detect a disconnection or short circuit of the first conducting wires 1110 or the second conducting wires 1120.

FIG. 7C illustrates a first logic unit 1240, according to an exemplary embodiment of the inventive concept. Since the first and second conducting wires 1110 and 1120 of the top layer 1000 are disposed across both ends of the integrated circuit 100, the respective lengths of the first and second conducting wires 1110 and 1120 may be relatively long. As a result, the capacitance of the first and second conducting wires 1110 and 1120 may be high. Thus, current consumption may be increased to change data applied to the first and second conducting wires 1110 and 1120, and to transmit signals applied to the first and second conducting wires 1110 and 1120, which may increase overall power consumption. To prevent or reduce this increase in overall power consumption, the first logic unit 1200 or the second logic unit 1300 may include a plurality of switches, each of which is connected to the first or second conducting wires 1110 or 1120. The switches may be controlled by the detecting unit 2100 and may include a tri-state buffer. The switches may disable transmission of data transmitted through the first conducting wires 1110 under the control of the detecting unit 2100.

As shown in FIG. 7C, the first logic unit 1240 may include flip-flops 1241, multiplexers 1242, and tri-state buffers 1243. The flip-flops 1241, multiplexers 1242, and tri-state buffers 1243 may be controlled by the shift signal SHIFT, the selection signal SEL, and an output enable signal OE, which are received from the detecting unit 2100. As described with reference to FIG. 7B, in an initial operation of the security device 1500, until a series of first pattern signals PAT_1 received from the detecting unit 2100 is output from output terminals of the flip-flops 1241 included in the first logic unit 1240, the detecting unit 2100 may control the shift signal SHIFT and the selection signal SEL. In addition, the detecting unit 2100 may control the output enable signal OE such that output data of the flip-flops 1241 may not be transmitted through the first conducting wires 1110. Thus, data applied to the first conducting wires 1110 may be prevented from being changed until the flip-flops 1241 output a series of the first pattern signals PAT_1 through the first conducting wires 1110, which may reduce power consumption.

FIG. 7D illustrates a first logic unit 1250, according to an exemplary embodiment of the inventive concept. In order to reduce the space occupied by the first logic unit 1250, some of the flip-flops utilized in the exemplary embodiments described above may be replaced with a combinational logic circuit. For example, the first logic unit 1250 may include at least one flip-flop 1251 and one or more combinational logic circuits 1252. Each flip-flop 1251 outputs input data according to an edge of the shift signal SHIFT received from the detecting unit 2100. Each combinational logic circuit 1252 may perform a logical operation on input data, and may output the result of the logical operation after a propagation delay of the combinational logic circuits 1252. The number of flip-flops 1251 and combinational logic circuits 1252 included in the first logic unit 1250 may be changed according to the space constraints and requirements of different integrated circuits.

In FIGS. 7B through 7D, the first logic units 1230, 1240, and 1250 include flip-flops. As shown in FIG. 7A, the flip-flops may be replaced by latches, that receive an additional shift signal from the detecting unit 2100.

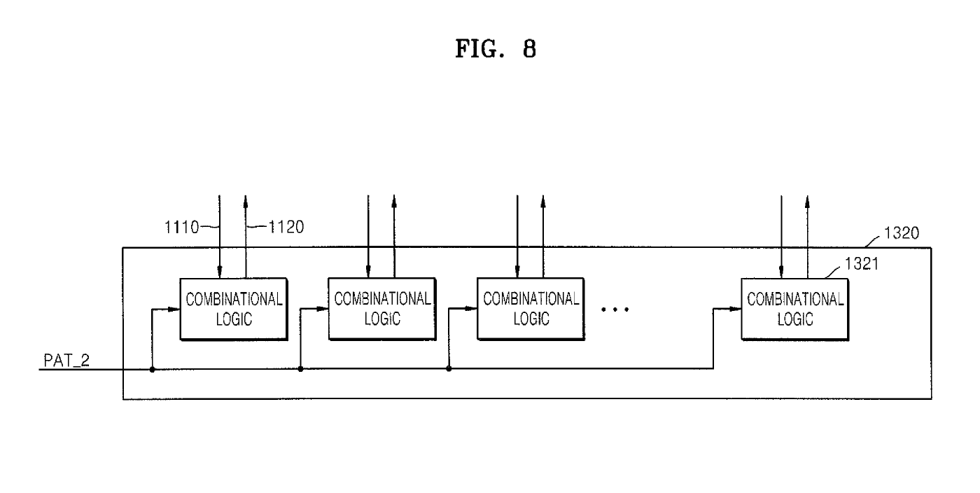

FIG. 8 illustrates a second logic unit 1320, according to an exemplary embodiment of the inventive concept, which is a modified version of the second logic unit 1300 of FIG. 5. Herein, when reference is made to the second logic unit 1300, it is to be understood that the referenced second logic unit 1300 may be replaced with the second logic unit 1320. The second logic unit 1320 may include a plurality of combinational logic circuits 1321, and may receive the second pattern signal PAT_2 from the detecting unit 2100. A combinational logic circuit 1321 included in the second logic unit 1320 may perform a logical operation on the second pattern signal PAT_2, as well as on data received from the first conducting wires 1110, and may transmit the result of the logical operation through the second conducting wires 1120. The second logic unit 1320 may receive the second pattern signal PAT_2, which may prevent or reduce the likelihood of an unauthorized user being able to predict data that is transmitted through the first conducting wires 1110 and the second conducting wires 1120.

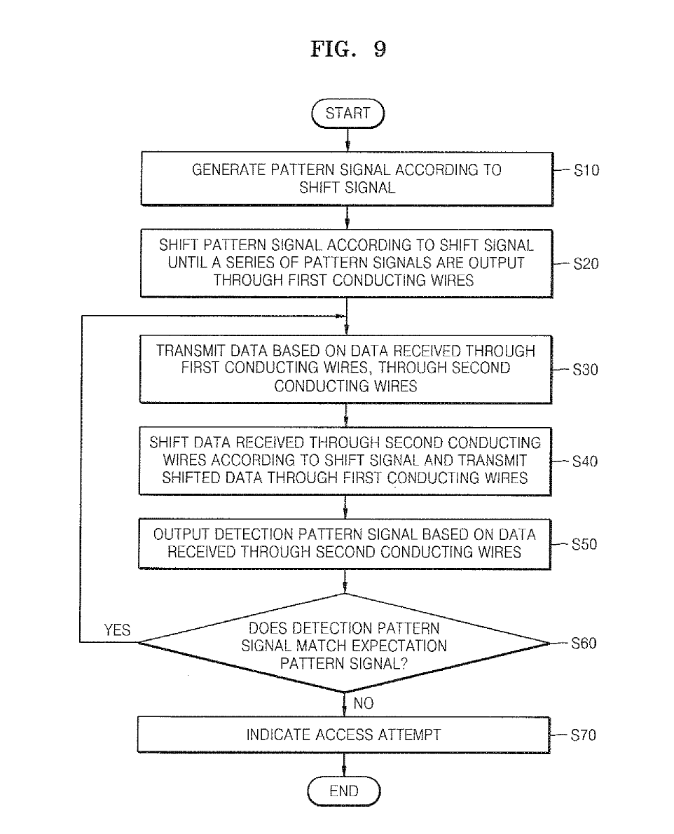

FIG. 9 is a flowchart showing a method of an operation of a security device 1500, according to an exemplary embodiment of the inventive concept. The pattern generating unit 2220 included in the detecting unit 2100 may generate a pattern signal PAT_IN according to a shift signal SHIFT transmitted from the control unit 2110 (S 10). As described above, the pattern generating unit 2220 may include a random number generator for generating at least one random number, and the pattern signal PAT_IN may contain a random number generated by the random number generator. The first logic unit 1200 of the top layer 1000 may receive the pattern signal PAT_IN from the pattern generating unit 2220.

According to the shift signal SHIFT received from the detecting unit 2100, the first logic unit 1200 may shift a pattern signal PAT_IN until a series of pattern signals are capable of being transmitted through first conducting wires 1110 (S20). In addition, the pattern generating unit 2220 may generate different pattern signals for respective shift signals, and may transmit the different pattern signals to the first logic unit 1200. The second logic unit 1300 may receive data through the first conducting wires 1110, and may transmit data based on the received data to the first logic unit 1200 through second conducting wires 1120 (S30). As described above, the second logic unit 1300 may perform a logical operation on data received through the first conducting wires 1110, and may transmit data through the second conductive wires 1120 as a result of the logical operation.

The first logic unit 1200 may shift the data received through the second conducting wires 1120 according to the shift signal SHIFT, and may transmit the shifted data through the first conductive wires (S40). As shown in FIG. 7B, the first logic unit 1230 may include a plurality of multiplexers 1232, may select one from among a series of pattern signals received from the pattern generating unit 2220 and the data received through the second conductive wires 1120, and may transmit the selected one of pattern signals through the first conducting wires 1110.

The first logic unit 1200 may transmit a detection pattern signal PAT_DET based on the data received through the second conducting wires 1120 to the detecting unit 2100 (S50), and the detecting unit 2100 may compare the detection pattern signal PAT_DET with the expectation pattern signal PAT_EXP (S60). When the detection pattern signal PAT_DET matches the expectation pattern signal PAT_EXP, processes for transmitting and receiving data through the first and second conduction wires 1110 and 1120 according to the shift signal SHIFT, and for comparing the detection pattern signal PAT_DET with the expectation pattern signal PAT_EXP may be repeated. If a disconnection or short circuit occurs, and the detection pattern signal PAT_DET does not match the expectation pattern signal PAT_EXP, the detecting unit 2100 may output a signal indicting that an unauthorized attempt to access the integrated circuit 100 has occurred (S70).

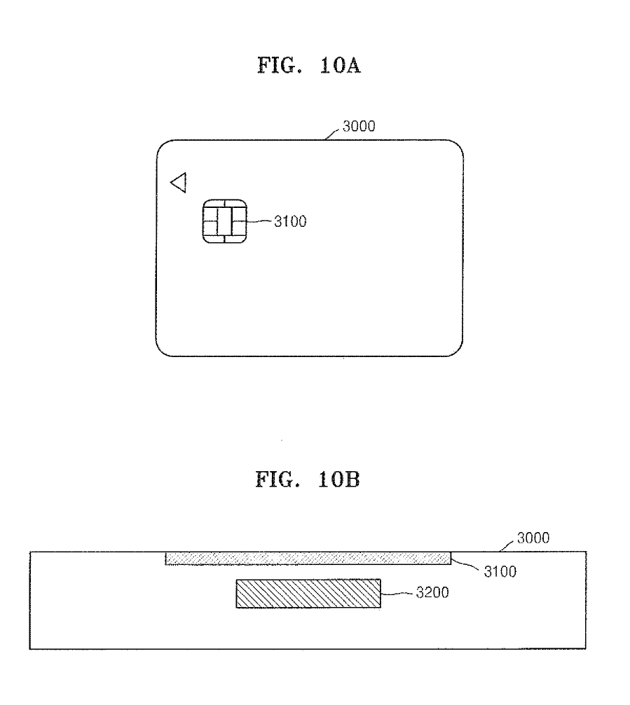

FIGS. 10A and 10B respectively show a plan view and a cross-sectional view of a smart card 3000 including a security device, according to an exemplary embodiment of the inventive concept. The smart card 3000 may be any type of portable card having various uses such as, for example, electronic payment. The smart card 3 000 may include a port region 3100 and a microchip 3200. The port region 3100 may be connected to the microchip 3200 through a plurality of wires. An external device and the microchip 3200 may communicate with each other through the port region 3100. The microchip 3200 installed in the smart card 3000 may include the security device according to the aforementioned exemplary embodiments. Unauthorized users may probe data stored in the smart card 3000 to attempt to disable or circumvent the security features of the smart card 3000, or to attempt to obtain or change the data stored in the microchip 3200. In an exemplary embodiment, the security device 1500 may be positioned on a top layer 1000 of the microchip 3200, and may prevent or reduce the likelihood of an unauthorized user gaining unauthorized access to the smart card 3000.

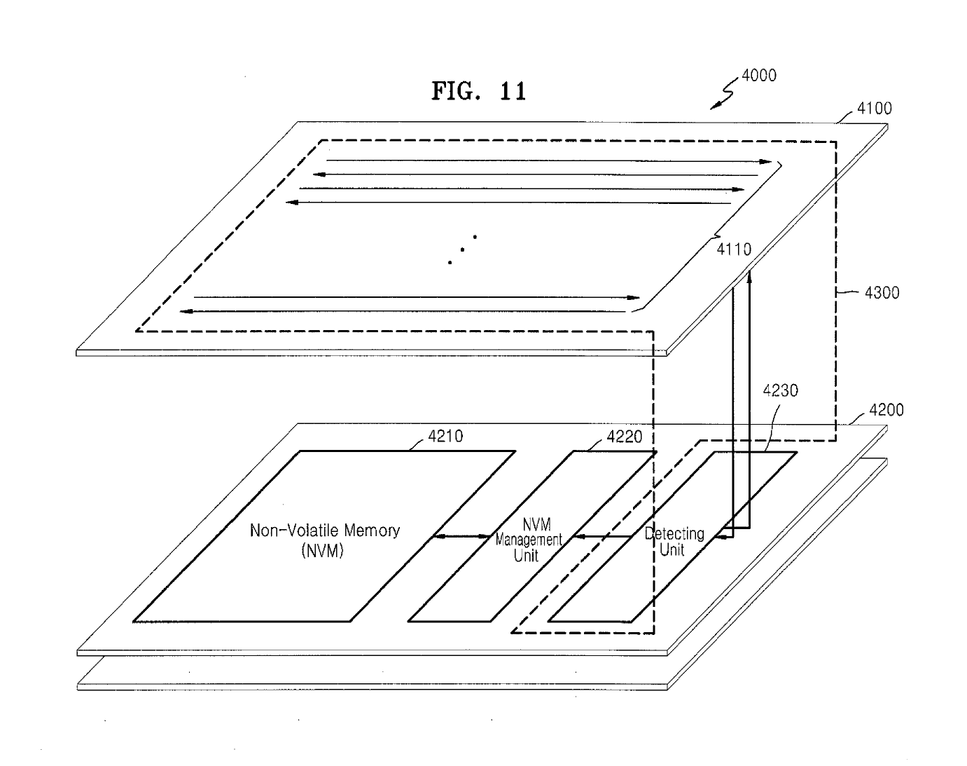

FIG. 11 is a block diagram of an integrated circuit 4000 including a security device 4300, according to an exemplary embodiment of the inventive concept. The integrated circuit 4000 may include one or more layers, and a top layer 4100 may include a plurality of conducting wires 4110. A lower layer 4200 may include a non-volatile memory (NVM) 4210, a NVM management unit 4220, and a detecting unit 4230. The non-volatile memory (NVM) 4210 may store secure data for which security should be maintained. The integrated circuit 4000 may include the security device 4300 to protect the non-volatile memory (NVM) 4210 from an unauthorized access attempt. The security device 4300 may include the conducting wires 4110 and the detecting unit 4230.

The security device 1500 and 4300 according to the aforementioned exemplary embodiments may be used in the integrated circuit 4000. According to an exemplary embodiment of the inventive concept, the detecting unit 4230 may monitor data transmitted through the conducting wires 4110 of the top layer 4100. When a disconnection or short circuit occurs in the conducting wires 4110, the detecting unit 4230 may detect the disconnection or short circuit, and may output an error signal. The NVM management unit 4220 may receive the error signal from the detecting unit 4230, and may perform an operation that prevents or reduces the likelihood of unauthorized users accessing data stored in the non-volatile memory (NVM) 4210. For example, when the NVM management unit 4220 receives the error signal, the NVM management unit 4220 may erase the data stored in the non-volatile memory (NVM) 4210. In addition, the NVM management unit 4220 may prevent an operation(s) of a control circuit included in the non-volatile memory (NVM) 4210 from being performed such that the data stored in the non-volatile memory (NVM) 4210 may not be output from the non-volatile memory (NVM) 4210.

While the inventive concept has been particularly shown and described with reference to the exemplary embodiments thereof, it will be understood by those of ordinary skill in the art that various changes in form and detail may be made therein without departing from the spirit and scope of the inventive concept as defined by the following claims.

What is claimed is:

1. A security device, comprising:
a shield comprising at least one first conducting wire and at least one second conducting wire;
a first logic unit configured to receive a first pattern signal, transmit data based on the first pattern signal through the at least one first conducting wire, and output a detection pattern signal based on data received through the at least one second conducting wire;
a second logic unit configured to perform a logical operation on the data received through the at least one first conducting wire and transmit a result of the logical operation through the at least one second conducting wire; and
a detecting unit configured to provide the first pattern signal to the first logic unit, receive the detection pattern signal from the first logic unit, and detect an unauthorized access attempt.

2. The security device of claim 1, wherein the detecting unit is configured to provide a second pattern signal to the second logic unit, and
wherein the second logic unit is configured to transmit a result of a logical operation performed on the data received through the at least one first conducting wire and the second pattern signal through the at least one second conducting wire.

3. The security device of claim 1, wherein the security device is disposed on a plurality of layers,
wherein the shield and the first and second logic units are disposed on a top layer from among the plurality of layers, and
wherein the detecting unit is disposed on a lower layer from among the plurality of layers.

4. The security device of claim 1, wherein the at least one first conducting wire is one of a plurality of first conducting wires, the at least one second conducting wire is one of a plurality of second conducting wires, and the shield comprises the plurality of first conducting wires and the plurality of second conducting wires,
wherein the first logic unit is configured to shift data received through the plurality of second conducting wires and transmit the shifted data through the plurality of first conducting wires, and
wherein the detecting unit is configured to control a shift operation of the first logic unit.

5. The security device of claim 4, wherein the first logic unit comprises a plurality of flip-flops or latches, and
wherein an output terminal of each of the flip-flops or latches is connected to one of the plurality of first conducting wires.

6. The security device of claim 4, wherein the detecting unit is configured to control the first logic unit to irregularly perform a shift operation.

7. The security device of claim 4, wherein the first logic unit comprises a plurality of switches respectively connected to the plurality of first conducting wires, and
wherein the detecting unit is configured to control the plurality of switches and disable transmission of data through the plurality of first conducting wires.

8. The security device of claim 4, wherein the first logic unit comprises a plurality of combinational logic circuits configured to perform a logical operation on the data received through the plurality of second conducting wires, and transmit an output of the logical operation through at least one of the plurality of first conducting wires.

9. The security device of claim 1, wherein the detecting unit comprises:
a pattern generating unit configured to generate at least one pattern signal;
a control unit configured to control the pattern generating unit and generate an expectation pattern signal based on the at least one pattern signal; and
a comparator configured to receive the detection pattern signal and the expectation pattern signal and compare the detection pattern signal and the expectation pattern signal with each other.

10. The security device of claim 9, wherein the pattern generating unit comprises a random number generator configured to generate a random number in response to a control signal received from the control unit.

11. The security device of claim 10, wherein the random number generator comprises a pseudo random number generator configured to generate each of all possibly generable numbers at least once during a single period.

12. The security device of claim 1, wherein the security device is configured to detect an unauthorized attempt to access an integrated circuit comprising a smart card, and
wherein the shield is disposed on an top layer of the integrated circuit.

13. An integrated circuit comprising a plurality of layers, comprising:
a shield disposed on a first layer from among the plurality of layers and comprising at least one first conducting wire and at least one second conducting wire;
a first logic unit disposed on the first layer and configured to receive a first pattern signal, transmit data based on the first pattern signal through the at least one first conducting wire, and output a detection pattern signal based on data received through the at least one second conducting wire;
a second logic unit disposed on the first layer and configured to perform a logical operation on the data received through the at least one first conducting wire, and transmit a result of the logical operation through the at least one second conducting wire;
a secure circuit unit disposed on a second layer disposed below the first layer; and
a detecting unit disposed on the second layer and configured to provide the first pattern signal to the first logic unit, receive the detection pattern signal from the first logic unit, and detect an unauthorized access attempt.

14. The integrated circuit of claim 13, wherein the at least one first conducting wire is one of a plurality of first conducting wires, the at least one second conducting wire is one of a plurality of second conducting wires, and the shield comprises the plurality of first conducting wires and the plurality of second conducting wires,
wherein the first logic unit is configured to shift data received through the plurality of second conducting wires and transmit the shifted data through the plurality of first conducting wires, and
wherein the detecting unit is configured to control a shift operation of the first logic unit.

15. The integrated circuit of claim 13, wherein the secure circuit unit comprises a non-volatile memory and a non-volatile memory management unit, and
wherein the non-volatile memory management unit is configured to change data stored in the non-volatile memory in response to a signal received from the detecting unit.

16. A security device, comprising:
a logic circuit disposed on a top layer of an integrated circuit, and configured to output a detection pattern signal;
a secure circuit disposed on a lower layer of the integrated circuit; and
a detecting unit disposed on the lower layer, and-configured to receive the detection pattern signal from the logic circuit, provide a pattern signal and a control signal to the logic circuit, and provide an error signal to the secure circuit indicating an unauthorized access attempt based on a comparison of the detection pattern signal and an expectation pattern signal.

17. The security device of claim 16, wherein the logic circuit comprises a first logic unit and a second logic unit operatively coupled to the first logic unit.

18. The security device of claim 17, wherein the first logic unit comprises a plurality of flip-flops or latches.

19. The security device of claim 17, wherein the detecting unit comprises:
a pattern generating unit configured to generate the pattern signal;
a control unit configured to control the pattern generating unit and generate the expectation pattern signal based on the pattern signal; and
a comparator configured to receive the detection pattern signal and the expectation pattern signal and compare the detection pattern signal and the expectation pattern signal with each other.

20. The security device of claim 17, wherein the detecting unit is configured to control the first logic unit to irregularly perform a shift operation.
